(19) United States
(12) Patent Application Publication
(10) Pub. No.: US 2018/0333807 A1
(43) Pub. Date: Nov. 22, 2018

(54) LASER PROCESSING DEVICE, THREE-DIMENSIONAL SHAPING DEVICE, AND LASER PROCESSING METHOD

(71) Applicant: KABUSHIKI KAISHA TOYOTA CHUO KENKYUSHO, Nagakute-shi, Aichi (JP)

(72) Inventors: Kazuo HASEGAWA, Nagakute-shi (JP); Satoru KATO, Nagakute-shi (JP); Tadashi ICHIKAWA, Nagakute-shi (JP); Masatoshi YONEMURA, Nagakute-shi (JP)

(73) Assignee: KABUSHIKI KAISHA TOYOTA CHUO KENKYUSHO, Nagakute-shi, Aichi (JP)

(21) Appl. No.: 15/772,469

(22) PCT Filed: Mar. 17, 2017
(86) PCT No.: PCT/JP2017/011017

§ 371 Date: Apr. 30, 2018

(30) Foreign Application Priority Data
Mar. 18, 2016 (JP) 2016-056211

(51) Int. Cl. B23K 26/342; B33Y 30/00; B33Y 10/00; B33Y 50/02; B23K 26/06; B23K 26/0622

(52) U.S. Cl. CPC B23K 26/342; B33Y 30/00; B33Y 10/00; B23K 26/0648; B23K 26/0617; B23K 26/0622; B23K 26/0626; B33Y 50/02

(57) ABSTRACT

A laser processing device includes plural laser sources and a focusing section that focuses respective light beams of the plural laser sources to form plural focus points on a workpiece, and that focuses such that respective portions of at least some of the plural focus points are overlapping.

### TECHNICAL FIELD

Technology of the present disclosure relates to a laser processing device, a three-dimensional shaping device, and a laser processing method.

### BACKGROUND ART

With regard to laser processing devices, in situations where various investigations have been made to improve processing characteristics, and especially to raise energy efficiency, investigations have also been made into laser processing devices employing plural beam spots or plural wavelengths. Non-Patent Document 1, for example, describes a known example of such an investigation. The laser processing device described in Non-Patent Document 1 attempts to control input heat distribution and improve processing characteristics by spatially splitting a beam of a laser source. Namely, plural optical systems (focusing lenses) having different focal point positions are employed for a single beam to control input heat, and processing such as cutting or welding is performed. Note that “input heat” refers to the amount of heat applied from the exterior to the processing point and the vicinity thereof during processing.

Further, Non-Patent Document 2 describes another example of a laser processing device in which improving energy efficiency was investigated. The laser processing device described in Non-Patent Document 2 employs light sources of plural wavelengths, and emits light from a semiconductor laser and light from a YAG laser onto the same focus point using a single multimode fiber. The laser processing device described by Non-Patent Document 2 utilizes the fact that a wavelength of light from a single semiconductor laser is absorbed by Al (aluminum) highly efficiently.

### CITATION LIST

### Non Patent Literature

NPL 1: J. Xie, Welding Journal 223-S, 2002
NPL 2: K. Miura et al., JLMN-Journal of Laser Micro/Nanoengineering, Vol. 6(3), 225-230, 2011

### SUMMARY OF INVENTION

### Technical Problem

In laser processing devices that employ plural beam spots or plural wavelengths, it is conceivable that employment of synergistic effects between the plural beam spots or between the plural wavelengths will be important technology for improving processing characteristics.

Regarding this point, the mere presence of plural beam spots is not expected to give rise to synergistic effects between plural beam spots in optical systems, such as the laser processing device described by Non-Patent Document 1, which is implemented by splitting a single-wavelength laser beam. Namely, in the laser processing device described by Non-Patent Document 1, for example, phenomena such as heterodyne effects caused by interference do not occur since two beams having the same wavelength are merely overlapped at the focus point. Accordingly, absorption characteristics are not expected to be improved by beam superimposition.

Further, although laser light from different laser sources is employed in the laser processing device described by Non-Patent Document 2, interactions such as heterodyne effects do not occur after delivery through a multimode fiber. Further, controlling input heat profiles at the focus point is difficult in cases in which plural laser beams obtained from the same emitting end are focused by the same lens. The processing characteristics of a laser processing device are generally determined by the wavelength of the laser light (namely, independent absorption characteristics) and the absorption characteristics of the workpiece, and the accompanying input heat distribution is mainly defined by an emission profile.

Technology disclosed herein provides a laser processing device, a three-dimensional shaping device, and a laser processing method that enable a profile of heat input to a workpiece to be controlled with high precision, and that achieve processing with high energy efficiency.

### Solution to Problem

A laser processing device according to a first aspect includes plural laser sources and a focusing section that focuses respective light beams of the plural laser sources to form plural focus points on a workpiece, such that respective portions of at least some of the plural focus points are overlapping.

A laser processing device according to a second aspect is the laser processing device according to the first aspect, wherein respective lights of the plural laser sources have identical wavelengths, sizes of the plural focus points differ from one another, and one of the focus points internally encompasses another of the focus points.

A laser processing device according to a third aspect is the laser processing device according to the second aspect, wherein the plural respective laser sources have been split from a single laser source.

A laser processing device according to a fourth aspect is the laser processing device according to any one of the first aspect to the third aspect, further including a controller that, when performing laser processing, after melting the workpiece at a region where two of the focus points are overlapped, controls an input heat profile at a region where the two focus points do not overlap.

A laser processing device according to a fifth aspect is the laser processing device according to the first aspect, wherein respective lights of the plural laser sources have different wavelengths, sizes of the plural focus points differ from one another, and one of the focus points internally encompasses another of the focus points.

A laser processing device according to a sixth aspect is the laser processing device according to the first aspect or the fifth aspect, wherein the plural laser sources is two laser sources having mutually different wavelengths, and the laser processing device further includes a controller that, when performing laser processing, after melting the workpiece at a region where two of the focus points are overlapped, controls an input heat profile at a region where the two focus points do not overlap.

A laser processing device according to a seventh aspect is the laser processing device according to any one of the first aspect of the sixth aspect, wherein the focusing section includes an optical system that focuses each of the respective light beams.

A three-dimensional shaping device according to an eighth aspect includes a laminating section including a material supply section that supplies a material for performing lamination to form a laminated object, and the laser processing device according to any one of the first aspect to the seventh aspect, wherein the laminating section performs lamination by supplying the material onto the laminated object from the material supply section while moving the laminated object relative to the material supply section and the light beams, and by emitting the light beams onto the supplied material.

A laser processing method according to a ninth aspect is performed by a laser processing device that includes a plural laser sources and a focusing section that focuses respective light beams of the plural laser sources to form plural focus points on a workpiece, the laser processing method includes focusing using the focusing section such that respective portions of at least some of the plural focus points are overlapping.

A laser processing method according to a tenth aspect is the laser processing method according to the ninth aspect, wherein the plural laser sources is two laser sources having mutually different wavelengths, and the laser processing method further includes melting the workpiece in a region where two of the focus points are overlapped, and controlling an input heat profile at a region where the two focus points are not overlapping.

### Advantageous Effects of Invention

One exemplary embodiment of technology disclosed herein has an advantageous effect of enabling a laser processing device, a three-dimensional shaping device, and a laser processing method to be provided that enable a profile of heat input to a workpiece to be controlled with higher precision, and that achieve processing with higher energy efficiency.

### BRIEF DESCRIPTION OF DRAWINGS

FIG. 1A is a diagram illustrating an example of a configuration of a laser processing device according to a first exemplary embodiment, and a beam spot of the laser processing device.

FIG. 1B is an enlarged view of a superimposition spot.

FIG. 1C is an enlarged view of a superimposition spot.

FIG. 2A is a graph for explaining principles of a laser processing device according to an exemplary embodiment, and is a graph illustrating an example of a mode of time-wise changes in a carrier component and an envelope component.

FIG. 2B is a graph for explaining principles of a laser processing device according to an exemplary embodiment, and is a graph illustrating an example of intensity modulation components for processing frequencies.

FIG. 2C is a graph for explaining principles of a laser processing device according to an exemplary embodiment, and is a graph illustrating an example of a mode of change to modulation intensity with respect to changes in power ratio.

FIG. 3 is a graph illustrating an example of a configuration of a laser processing device according to a second exemplary embodiment.

FIG. 4 is a graph illustrating an example of a configuration of a laser processing device according to a third exemplary embodiment.

FIG. 5A is a diagram illustrating an example of a configuration of a laser processing device according to a fourth exemplary embodiment.

FIG. 5B is a diagram illustrating a modified example of a configuration of a laser processing device according to the fourth exemplary embodiment.

FIG. 6A is a diagram illustrating an example of a configuration of a 3D printer according to a fifth exemplary embodiment.

FIG. 6B is a diagram illustrating an example of a mode of a metal powder/conveyance gas channel with a shielding gas channel in cases in which a nozzle is viewed from a leading end.

FIG. 7 is a block diagram illustrating an example of a hardware configuration of an electrical system of a laser processing device according to an exemplary embodiment.

FIG. 8 is a conceptual diagram illustrating an example of a mode in which a program is installed to a laser processing device from a storage medium stored with the program.

### DESCRIPTION OF EMBODIMENTS

Detailed explanation follows regarding exemplary embodiments of technology disclosed herein, with reference to the drawings.

### First Exemplary Embodiment

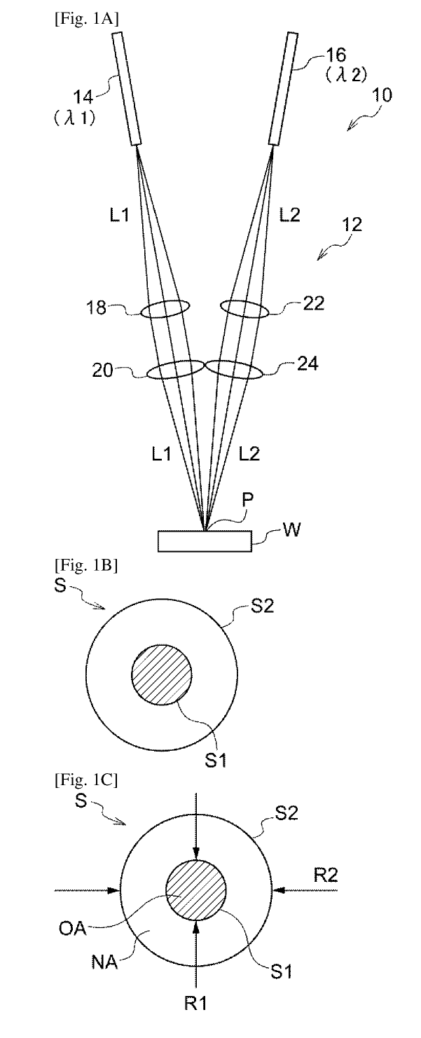

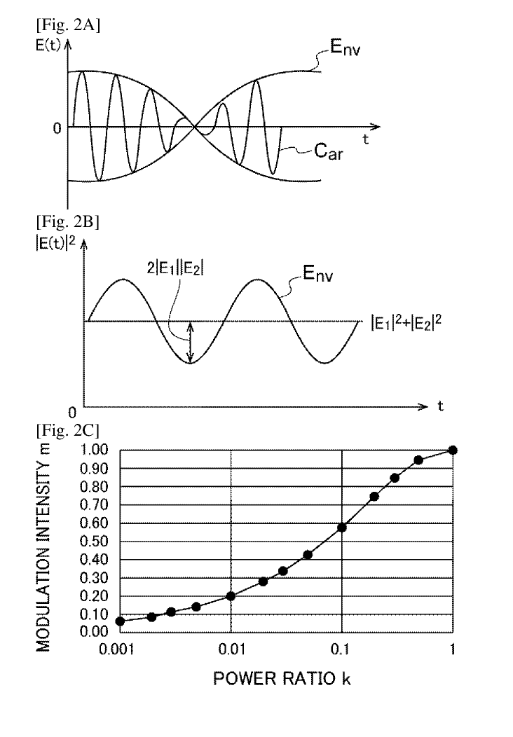

Explanation follows regarding a laser processing device 10 according to an exemplary embodiment, with reference to FIG. 1A, FIG. 1B, FIG. 1C, FIG. 2A, FIG. 2B, and FIG. 2C. As illustrated as an example in FIG. 1A, the laser processing device 10 includes an optical system 12, a laser source 14, and a laser source 16. Note that, although light sources of plural wavelengths can be employed in technology disclosed herein, in the present exemplary embodiment explanation is given using an example in which two wavelengths are employed.

The laser source 14 and the laser source 16 are heat sources that supply heat during processing. A solid-state laser, a fiber laser, or the like may be employed therefor in the present exemplary embodiment, but there are no particular limitations thereto. In the present exemplary embodiment, the wavelength of the laser source 14 is λ1, the wavelength of the laser source 16 is λ2, and both of these wavelengths are different (λ1≠λ2). For example, wavelengths within a 1.00 μm band may be set as the wavelengths λ1 and λ2. Further, although the laser sources 14 and 16 are typically continuous wave (CW) types, pulsed light may be employed. Further, the polarization state of the laser lights of the laser sources 14 and 16 according to the present exemplary embodiment is one of linear polarization. However, there is no limitation thereto, and in consideration of processing efficiency and the like, circularly polarized light may be employed, or one laser source may be a source of circularly polarized light and the other laser source may be a source of linearly polarized light.

The optical system 12 is a section where light emitted from the laser source 14 and light emitted from the laser source 16 are each independently focused. As illustrated as an example in FIG. 1A, the optical system 12 is configured including: a lens 18 and a lens 20 that focus a light beam L1 emitted from the laser source 14; and a lens 22 and a lens 24 that focus a light beam L2 emitted from the laser source 16.

As illustrated as an example in FIG. 1A, the light beam L1 emitted from the laser source 14 and the light beam L2 emitted from the laser source 16 are each focused on the surface of a workpiece W after having been focused by the optical system 12, thereby forming a spot S, which is a spot where a laser beam spot (focus point) of each laser beam is superimposed on a processing point P (a region where processing is carried out on the workpiece W). Note that the formation position of the superimposition spot S on the workpiece W is not necessarily limited to the surface of the workpiece W, and the superimposition spot S may be formed inside the workpiece W in accordance with the material and the like of the workpiece W.

FIG. 1B illustrates an enlarged view of a superimposition spot S. As illustrated as an example in FIG. 1B, the superimposition spot S according to the present exemplary embodiment is formed by superimposing the spot S1 from the laser source 14 (the light beam L1) with the spot S2 from the laser source 16 (the light beam L2). In the superimposition spot S, the energy density in the region where the spot S1 is superimposed with the spot S2 is higher than the energy density of regions where the spot S1 is not superimposed with the spot S2. In the present exemplary embodiment, although the superimposition spot S is formed such that the spot S2 encompasses the spot S1 as illustrated as an example in FIG. 1B, the superimposition state of the spot S1 with the spot S2 is not limited thereto. Further, in the present exemplary embodiment, although explanation is given using an example in which the shapes of the spots S, S1, and S2 are circular shapes, there is no limitation thereto. In accordance with the details of the processing and the like, an appropriate shape such as a straight line shape or a rectangular shape may be selected, and the shapes of the spots may differ from one another. Note that the superimposition state of the spot S1 with the spot S2 is described in detail later.

As illustrated as an example in FIG. 1C, in an superimposition spot S, a region in which a spot S1 and a spot S2 are superimposed (the region of spot S1 in the example illustrated in FIG. 1C) is referred to as a “superimposition region OA”, and a region in which the spot S1 and the spot S2 are not superimposed is referred to as a “no-superimposition region NA” (the region having only spot S2 in the example illustrated in FIG. 1C). Further, a focus diameter (spot size) R1 of the spot S1 and a focus diameter (spot size) R2 of the spot S2 are defined as illustrated as an example in FIG. 1C. The focus diameters according to the present exemplary embodiment are, for example, R1=50 μm and R2=100 μm.

As illustrated as an example in FIG. 7, the laser processing device 10 includes a controller 300. The controller 300 includes a CPU 302 serving as a central processing unit, a primary storage section 304, and a secondary storage section 306. Examples of the primary storage section 304 include RAM serving as random access memory. Examples of the secondary storage section 306 include ROM serving as read-only memory. Note that other examples of the secondary storage section 306 include non-volatile memory such as electrically erasable programmable read only memory (EEPROM) or flash memory.

The secondary storage section 306 stores various programs including a program 308, various profiles such as a beam profile and an input heat profile, various parameters, and the like.

The CPU 302, the primary storage section 304, and the secondary storage section 306 are connected to one another through a bus line 308. Accordingly, the CPU 302 reads the various programs from the secondary storage section 306, expands the various programs into the primary storage section 304, and executes each of the various programs.

In particular, the CPU 302 operates as a controller according to technology disclosed herein by executing the program 308. Namely, when performing laser processing, the CPU 302 controls the input heat profile at a region where there are not two overlapping focus points, after having caused melting of the workpiece in the region where the two focus points have been overlapped.

In cutting processing and welding processing of a workpiece such as metal, it is difficult to effectively use energy from a laser source since the ratio of laser light reflected by the surface of the workpiece is generally high. However, the absorption efficiency of the laser light can be raised by initially melting a portion of the surface of the workpiece using laser light emission.

Thus, in the present exemplary embodiment, the superimposition spot S where the two spots S1 and S2 are superimposed is focused on a processing point P, so as to first cause slight melting in the highly focused (high energy density) superimposition region OA. Thus, one laser beam is focused, the surface of the workpiece W is melted by the focused laser beam, and processing characteristics are improved compared to performing cutting processing or welding processing with the same laser beam profile as-is. Further, by configuring the no-superimposition region NA, the CPU 302 can independently control suitable beam profiles typical for executing cutting processing and welding processing, enabling processing to be performed with high energy efficiency.

Further, in the present exemplary embodiment, in the superimposition region OA, which is a region where the spots of two laser lights having different wavelengths are superimposed, heterodyne interference occurs due to interference between the two laser lights, and the heterodyne interference is used in the laser processing.

Namely, in the present exemplary embodiment employing two laser beams, heterodyne interference is caused by superimposing the laser beams having the wavelengths λ1 and λ2 (in other words, optical frequencies of ω1 and ω2). This then generates a superimposition beam of a carrier component expressed by frequency (ω1+ω2)/2 and an envelope component expressed by (ω1−2)/2. By selecting the frequencies ω1 and ω2 in accordance with the processing conditions, the frequency (ω1+ω2)/2 of the carrier component acts like a third wavelength λ3 that influences the absorption characteristics of the workpiece W, and the CPU 302 controls the processing characteristics using the frequency (ω1−ω2)/2 of the envelope component. It is thereby possible to achieve laser processing equivalent to having introduced a new wavelength with improved energy efficiency. Namely, the absorption characteristics of the superimposition region OA are determined by the carrier frequency and the absorption characteristics of the workpiece, and the absorption characteristics in the superimposition region OA can be raised by appropriately selecting the carrier frequency. Further, the carrier frequency could also be set such that such that the reflection ratio is raised at the superimposition region OA, if necessary. In such a case, the combination of the wavelengths λ1 and λ2 can be appropriately selected by considering the absorption wavelength characteristics of the workpiece W.

More detailed explanation follows regarding the heterodyne effect according to the present exemplary embodiment, namely, generation of the carrier component and the envelope component, with reference to FIG. 2. The electric field distributions of the two laser lights having different wavelengths are expressed by Equation 1 and Equation 2 below.

[Math.1]

E₁(t)=E₁·exp{j(ω₁t+φ₁)} Equation 1

[Math.2]

E₂(t)=E₂·exp{j(ω₂t+φ₂)} Equation 2

The two laser lights having the electric field distributions expressed by Equation 1 and Equation 2 are combined on the surface of the workpiece, and the electromagnetic field when interference has occurred is expressed by Equation 3 below, which is obtained by multiplying Equation 1 by Equation 2. Note that Equation 3 is derived when E₀=E₁=E₂ to simplify the logic.

$$[ Math .3 ]$$

$$E ( t ) = 2 {E}_{0} \cdot cos \{ \frac{( {ω}_{1} - {ω}_{2} ) t + ( {ϕ}_{1} - {ϕ}_{2} )}{2} \} \cdot exp \{ j \frac{( {ω}_{1} + {ω}_{2} ) t + ( {ϕ}_{1} + {ϕ}_{2} )}{2} \} \qquad Equation 3$$

It is apparent from Equation 3 that an electric field distribution from the carrier component expressed by frequency ωc=(ω1+ω2)/2, and an electric field component from the envelope component expressed by frequency e=(ω1−ω2)/2, are generated. FIG. 2A illustrates the carrier component Car and the envelope component Env on a plot having time on the horizontal axis and electric field E on the vertical axis. When the frequency (processing frequency) employed in the processing of the laser processing device 10 is ωc, from FIG. 2A, the intensity of the processing frequency ωc can be described as being rapidly modulated by the frequency ωe of the envelope component. Namely, in the superimposition region OA, the reflection ratio characteristics or the absorption characteristics for a material are similar to the characteristics for the laser light having frequency ωc, and the laser light having frequency ωc behaves as if intensity modulated by the frequency ωe.

However, when the heterodyne effect is represented, the optical intensity |E(t)|² of the envelope component is represented by Equation 4 below.

$$[ Math .4 ]$$

$$\vert E ( t ) {\vert}^{2} = ( {E}_{1} ( t ) + {E}_{2} ( t ) ) {( {E}_{1} ( t ) + {E}_{2} ( t ) )}^{*} = \\ \vert {E}_{1} {\vert}^{2} + \vert {E}_{2} {\vert}^{2} + 2 \cdot \vert {E}_{1} \vert \vert {E}_{2} \vert \cdot cos \{ ( {ω}_{1} - {ω}_{2} ) t + \\ ( {ϕ}_{1} - {ϕ}_{2} ) \} \qquad Equation 4$$

A plot of Equation 4 yields, for example, FIG. 2B. FIG. 2B is a plot obtained from the above, of the intensity modulation component for the processing frequency ωc.

FIG. 2C illustrates an amplitude magnitude (modulation intensity or brightness) of an interference signal generated by laser light from the laser source 14 and the laser source 16, which are two laser sources having different wavelengths. The power of the laser lights from the two laser sources are respectively denoted P1 and P2, and the power ratio k is defined as k=P1/P2. FIG. 2C has power ratio k on the horizontal axis, and change in the modulation intensity m is plotted against the power ratio k. In the example illustrated in FIG. 2C, for example, when k=1, namely, in cases in which the power of the laser lights from the two laser sources are equal, this means that the amplitude 2|E1|·|E2| illustrated in FIG. 2B is in a state of changing between 0 and a maximum value.

Here, explanation follows regarding polarization of laser light from the laser source 14 and the laser source 16 (wave polarization). In the laser processing device 10, it is necessary to match the planes of polarized light (wave polarization) to each other since interference phenomena between laser light from the laser source 14 and laser light from the laser source 16 is employed. Note that in the present exemplary embodiment, “match the planes of polarized light to each other” does not only refer to cases of matching perfectly, but also includes cases of matching with a predetermined permissible drop in interference.

The polarization of laser light from the laser source 14 and the laser source 16 according to the present exemplary embodiment is preferably linear polarization for both laser lights. It is most efficient to employ the characteristics of light beams produced by interference between linearly polarized light beams. However, interference between linearly polarized light and circularly polarized light (or randomly polarized light or unpolarized light), or interference between circularly polarized light beams can be employed. Although laser light sent using an optical fiber can be employed, for interference effects to be expected, it is preferable to employ laser light that has propagated through a single-mode optical fiber or low-dimension mode laser light delivered through an optical fiber capable of high-mode delivery. Note that “randomly polarized light” is polarized light in which the linear polarization direction of the light is aperiodically changed. “Unpolarized light” is light for which the linear polarization direction of the light is evenly mixed over a 360° range.

Next, explanation follows regarding the superimposition state of the spot S1 of the laser light from the laser source 14 with the spot S2 of the laser light from the laser source 16. As described above, in the present exemplary embodiment, at least a portion of the spot S1 and the spot S2 overlap with each other, namely, it is a presupposition that the spot S1 and the spot S2 are superimposed. However, there are various conceivable forms of this superimposition. In the case of two spots, a mode in which one spot is completely encompassed by the other spot, as illustrated as an example in FIG. 1B, is preferable. However, there is no limitation thereto; even modes in which the position of the spot S1 is offset from the position illustrated in FIG. 1B and a portion of the spot S1 falls outside of the spot S2 can be employed by, for example, providing a permissible range of lowered interference efficiency. Conversely, interference effects cannot be expected in cases in which the spot S1 and the spot S2 exist independently with no overlap at all.

Note that the number of spots is three or more in some cases since three or more laser sources can be employed in technology disclosed herein. When employing three or more spots, for example, three spots S3, S4, and S5 using three laser sources, a mode in which the spot S3 and the spot S4 are contained within the spot S5 is conceivable as an example. Further, in such cases, modes in which the spot S3 and the spot S4 do not overlap at all, modes in which the spot S3 is contained within the spot S4, and the like are conceivable inside the spot S5. Further, a mode in which a portion of at least one out of the spot S3 or the spot S4 falls outside of the spot S5 is also conceivable. Employing three or more spots enables the CPU 302 to control the input heat profile with high precision.

Next, explanation follows regarding an example case in which the processing performance of the laser processing device 10 is compared against the processing performance of a laser processing device according to related technology. The present example case is an example case in which a metal sheet is cut by both laser processing devices and the quality of the processing is compared.

### COMPARATIVE EXAMPLE

In the laser processing device according to related technology that employs a single laser source, mild steel having a plate thickness of 1.5 mm was cut using a laser light of a 900 W laser source constrained to a spot having a 300 μm focus diameter (diameter). It was found that a cut could be made with excellent product quality as a result. A cuff width needs to be controlled as a cutting margin (a width needed to blow away the melted metal), and an optimum width was 300 μm.

Present Exemplary Embodiment

Applying an optical system according to the present exemplary embodiment illustrated as an example in FIG. 1, mild steel having a sheet thickness of 1.5 mm was cut using a superimposed laser beam of the laser light of the laser source 14, which had a power of 300 W, constrained to the spot S1 having a focus diameter of 150 μm, and the laser light of the laser source 16, which had a power of 300 W, constrained to the spot S2 having a focus diameter of 300 μm. It was found that cutting of equivalent quality to that of the comparative example was possible as a result.

Namely, it was found that using the laser processing device 10 according to the present exemplary embodiment improved energy efficiency by approximately 33% ((1−300 W×2/900 W)×100).

As described in detail above, the laser processing device and the laser processing method according to the present exemplary embodiment achieve a laser processing device and a laser processing method having excellent energy efficiency by superimposing emitted light from plural laser sources having different wavelengths (in other words, optical frequencies) as described above at the processing point and forming the superimposition spot S as illustrated in FIG. 1B. Further, a laser processing device and a laser processing method are achieved in which the CPU 302 can control the input heat (energy density) input to the workpiece by controlling the overlap distribution of the beam. Namely, the CPU 302 controls the beam profile (the shape of the superimposition spot S) at the focus point of the plural beams (having different wavelengths and a focus characteristics), and input heat characteristics and absorption characteristics of the workpiece can be independently controlled by employing interference effects between the laser lights caused by the superimposition, thus achieving cutting or welding processing having high energy efficiency.

### Second Exemplary Embodiment

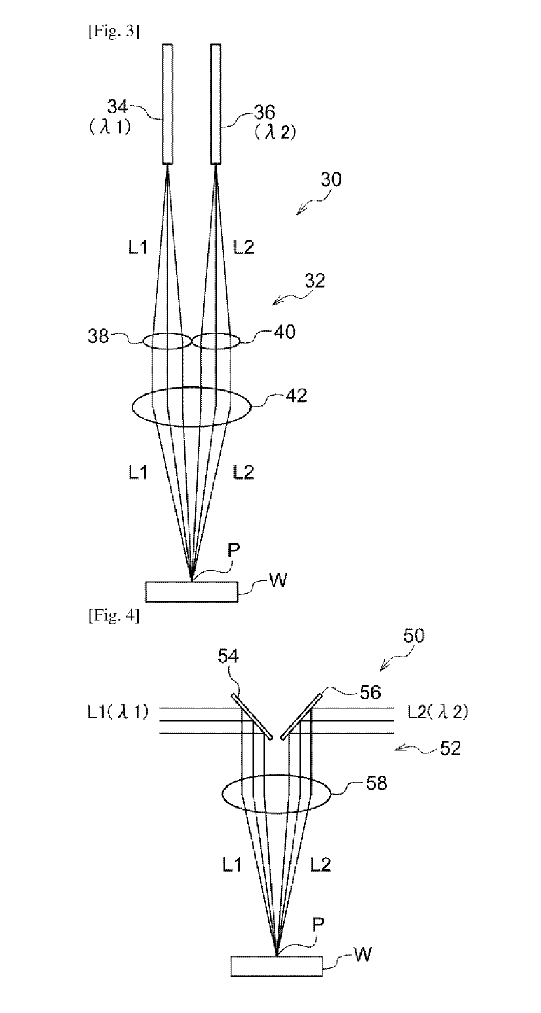

Explanation follows regarding a laser processing device 30 according to an exemplary embodiment, with reference to FIG. 3. The present exemplary embodiment is an embodiment in which the optical system of the exemplary embodiment above has been changed.

As illustrated as an example in FIG. 3, the laser processing device 30 includes a laser source 34, a laser source 36, and an optical system 32. The wavelength of the laser source 34 is λ1, and the wavelength of the laser source 36 is λ2 (≠λ1).

The optical system 32 according to the present exemplary embodiment is configured including lenses 38, 40, and 42. The lens 38 focuses a light beam L1 from the laser source 34. The lens 40 focuses a light beam L2 from the laser source 36. The light beam L1 focused by the lens 38 and the light beam L2 focused by the lens 40 are each further focused by the lens 42, and a superimposition spot S (see FIG. 1B) are formed at the processing point P of the workpiece W as a result.

The laser processing device according to the present exemplary embodiment enables the optical system to be configured more simply than in the exemplary embodiment above since the number of lenses is reduced by making some of the lenses common.

### Third Exemplary Embodiment

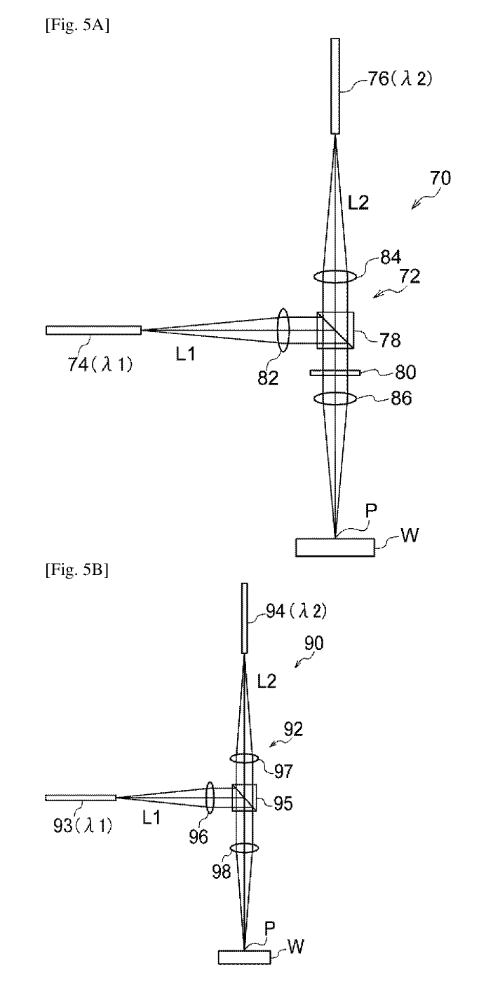

Explanation follows regarding a laser processing device 50 according to an exemplary embodiment, with reference to FIG. 4. The present exemplary embodiment is an embodiment in which the optical system of the exemplary embodiment above has been changed.

As illustrated as an example in FIG. 4, the laser processing device 50 includes a laser source having a wavelength λ1, a laser source having a wavelength λ2 (these are omitted from the drawings), and an optical system 52.

The optical system 52 according to the present exemplary embodiment is configured including mirrors 54 and 56, and a lens 58. A light beam L1 from the laser source having the wavelength λ1 is reflected at substantially a right angle by the mirror 54 and aimed toward the lens 58, and is focused at the processing point P of the workpiece W. A light beam L2 from the laser source having the wavelength λ2 is reflected at substantially a right angle by the minor 56 and aimed toward the lens 58, and is focused at the processing point P of the workpiece W. The superimposition spot S is formed at the processing point as a result.

The laser processing device according to the present exemplary embodiment enables the optical system to be configured more simply than in the exemplary embodiment above since the number of lenses is further reduced by applying mirrors to the optical system.

### Fourth Exemplary Embodiment

Explanation follows regarding a laser processing device according to an exemplary embodiment, with reference to FIG. 5. The present exemplary embodiment is an embodiment in which the optical system of the exemplary embodiment above has been changed. FIG. 5A illustrates a laser processing device 70 according to the present exemplary embodiment. FIG. 5B illustrates a laser processing device 90, which is a modified example of the laser processing device 70.

As illustrated as an example in FIG. 5A, the laser processing device 70 includes a laser source 74, a laser source 76, and an optical system 72. The wavelength of the laser source 74 is λ1, and the wavelength of the laser source 76 is λ2 (≠λ1). Laser light of the laser source 74 and laser light of the laser source 76 are both linearly polarized and polarized wave directions are orthogonal to each other.

The optical system 72 according to the present exemplary embodiment includes a polarizing prism 78, a ¼ waveplate 80, and lenses 82, 84, and 86. The polarizing prism 78 is an optical element that multiplexes two linearly polarized light beams having orthogonal wave polarization directions. The polarizing prism 78 multiplexes the laser light (light beam L1) from the laser source 74 with the laser light (light beam L2) from the laser source 76 and transmits the multiplexed laser light toward the ¼ waveplate 80. The ¼ waveplate 80 is an element that converts incident linearly polarized light into circularly polarized light. The ¼ waveplate 80 converts, into circularly polarized light, the laser light from the laser source 74 and the laser light from the laser source 76 that have been multiplexed by the polarizing prism 78, and forms the superimposition spot S at the processing point P of the workpiece W.

In particular, the laser processing device according to the present exemplary embodiment has an advantageous effect of enabling heterodyne interference to be stabilized by using a ¼ waveplate when employing the above described heterodyne interference between mutually orthogonally linearly polarized light beams respectively having a wavelength λ1 and a wavelength λ2, which are similar wavelengths. Further, the laser processing device according to the present exemplary embodiment enables dependency on polarization of the processing light to be reduced when, for example, cutting metal, since the laser light at the processing point P is circularly polarized light.

As illustrated as an example in FIG. 5B, the laser processing device 90 includes a laser source 93, a laser source 94, and an optical system 92. The wavelength of the laser source 93 is λ1, and the wavelength of the laser source 94 is λ2. The polarization state of the laser light of each laser source is one of circular polarization.

The optical system 92 according to the present exemplary embodiment is configured including a dichroic mirror 95 and lenses 96, 97, and 98. The dichroic minor 95 is an optical element that multiplexes two laser light beams having different wavelengths by reflecting one light beam and passing the other light beam. As illustrated as an example in FIG. 5B, multiplexing is performed by reflecting the light beam L1 from the laser source 93 and passing the light beam L2 from the laser source 94. The multiplexed light beam L1 and the light beam L2 are focused by the lens 98 and the superimposition spot S is formed at the processing point P of the workpiece W.

The laser processing device according to the present exemplary embodiment has an advantageous effect of enabling the optical system to be simplified since employing a dichroic mirror according to the present exemplary embodiment eliminates the need to employ a ¼ waveplate, particularly when applying, as the wavelength λ1 and the wavelength λ2, a combination of wavelengths having frequencies separated by a predetermined wavelength (for example, a combination of an infrared region wavelength and a visible wavelength in a 1 μm band). Further, the laser processing device according to the present exemplary embodiment is able to achieve a less expensive laser processing device, since a dichroic mirror is less expensive than a polarizing prism and there is no need to employ a ¼ waveplate.

### Fifth Exemplary Embodiment

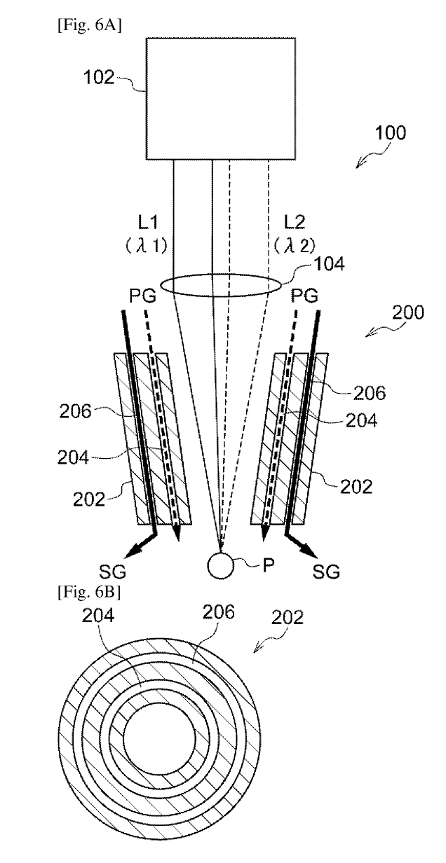

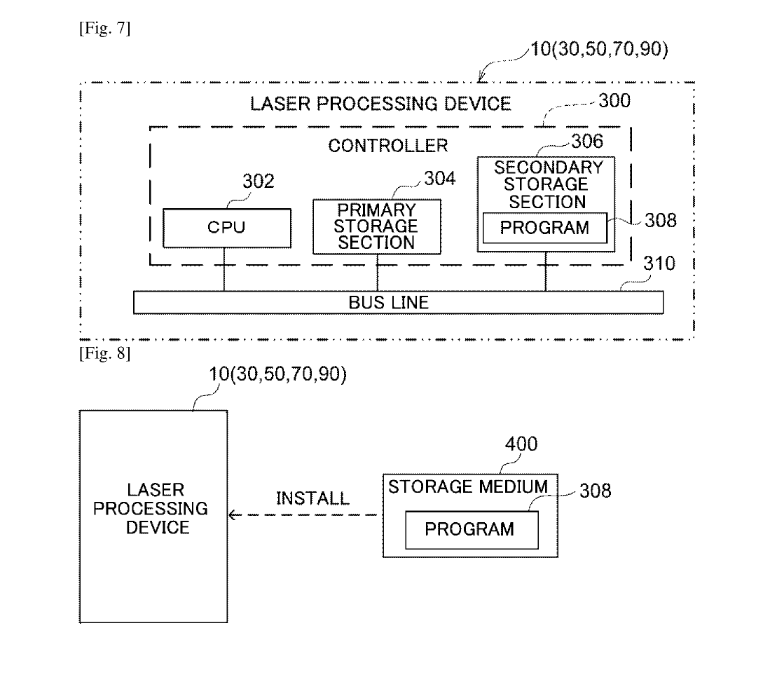

Explanation follows regarding a 3D printer (a three-dimensional shaping device) according to an exemplary embodiment that employs a laser processing device according to an exemplary embodiment above, with reference to FIG. 6A and FIG. 6B. The 3D printer is apparatus that shapes solid objects (three-dimensional objects) based on 3D CAD data or 3D CG data. The 3D printer employs, for example, a laminated shaping method as the shaping method. Minute focus diameter laser spots, namely, melted spots, are requested for the 3D printer to form a laminated object in some cases. The laser processing device according to the exemplary embodiments above is also suitable for achieving small melted spots such as those needed in the 3D printer.

Namely, in the laser processing device according to the present exemplary embodiment, laminated object production can be achieved with small melted spots by the CPU 302 independently controlling a region of strongest absorption and melting due to the superimposition region OA of the superimposition spot S, and a region that adjusts the amount of heat introduced to the entire object by the no-superimposition region NA, at the processing point P of the workpiece W.

As illustrated as an example in FIG. 6A, the 3D printer according to the present exemplary embodiment includes a processing light generator 100 and a metal powder supplying mechanism 200. The processing light generator 100 is a section having a similar function to the laser processing device described above. The processing light generator 100 includes a laser source 102 that outputs laser light beams having plural wavelengths (a case of two wavelengths is illustrated in the example illustrated in FIG. 6A) and a lens 104.

A light beam L1 having a wavelength λ1 and a light beam L2 having a wavelength λ2 output from the laser source 102 are focused by the lens 104 and the superimposition spot S is formed at the processing point P for forming the laminated shape.

The metal powder supplying mechanism 200 is configured including a nozzle 202; a metal powder source and a conveyance section therefor, which are omitted from the drawings; a conveyance gas and a conveyance section therefor; and a shielding gas and a conveyance section therefor. Note that the powder is not limited to a metal; a ceramic, a resin, or the like may be employed.

As illustrated as an example in FIG. 6A, the nozzle 202 includes a metal powder/conveyance gas channel 204 for supplying the metal powder serving as a laminating material (a material for performing lamination) together with a conveyance gas (for example, nitrogen gas) as a powder-mixed gas PG, and a shielding gas channel 206 for supplying a shielding gas SG (for example, nitrogen gas) for shielding the processing point P from the exterior during lamination. As illustrated as an example in FIG. 6B, the nozzle 202 is configured such that the metal powder/conveyance gas channel 204 and the shielding gas channel 206 are disposed in a concentric circle arrangement as viewed from the leading end of the nozzle 202. Then, in the processing light generator 100, laminating is performed by ejecting metal powder from the nozzle 202 while the light beams L1 and L2 are emitted on the processing point. When doing so, the processing point P where laminating is being performed is shielded by the shielding gas SG and an atmosphere of the conveyance gas is maintained around the processing point P.

In cases in which laminating is performed, as illustrated as an example in FIG. 6A the powder-mixed gas PG is discharged from the nozzle 202 and the light beams L1 and L2 from the laser source 102 are emitted onto the metal powder included in the powder-mixed gas PG. The energy of the spot S is received at the processing point P, the heated metal powder melts, and a laminated portion of solidified metal is formed.

Note that in the exemplary embodiments above, although explanation has been given regarding examples of modes in which there are plural laser sources having different wavelengths in the laser processing device, there is no limitation thereto. The wavelengths of the plural laser sources may be the same wavelength. Although heterodyne interference does not occur in such cases, after the processing point has been melted by the superimposition region OA having a predetermined energy density, the CPU 302 controls the processing characteristics by causing the energy of the no-superimposition region NA, which has a lower energy density than the superimposition region OA, to be absorbed, thereby employing the superimposition spot S to achieve an advantageous effect, namely, an advantageous effect of improved energy efficiency.

In each of the exemplary embodiments above, although explanation has been given regarding examples of modes in which the superimposition spot S is formed using plural laser sources, there is no limitation thereto. For example, a mode may be configured such that laser light from a single laser source is split to form the superimposition spot S. In such cases, configuration may be made such that, for example, laser light from a single laser source is split into plural laser light beams by a beam splitter or the like and the split plural laser light beams have the characteristics described above (energy density, encompassing relationship, and the like) so as to form the superimposition spot S. According to such a configuration, since the number of laser sources can be reduced, the advantageous effects of the superimposition spot S according to technology disclosed herein can be achieved using a laser processing device having a simpler configuration.

Note that in the exemplary embodiments above, although examples have been given of cases in which the program 308 is read from the secondary storage section 306, the program 308 does not necessarily need to be pre-stored on the secondary storage section 306. For example, as illustrated in FIG. 8, the program 308 may be first stored on an arbitrarily selected portable storage medium 400, such as an SSD, USB memory, or a CD-ROM. In such cases, the program 308 of the storage medium 400 is installed to the laser processing device 10 (30, 50, 70, 90), and the installed program 308 is executed by the CPU 302.

Further, the program 308 may be stored in a storage section such as another computer or a server device connected to the laser processing device 10 (30, 50, 70, 90) through a communication network (not illustrated in the drawings), and the program 308 may be downloaded by the laser processing device 10 (30, 50, 70, 90) when needed. In such cases, the downloaded program 308 is executed by the CPU 302.

Further, in the exemplary embodiments above, although examples have been given regarding cases in which a controller according to technology disclosed herein is implemented by a software configuration that employs a computer, technology disclosed herein is not limited thereto. For example, instead of a software configuration that employs a computer, the controller according to technology disclosed herein may be implemented using a hardware configuration alone, such as a field-programmable gate array (FPGA) or an application specific integrated circuit (ASIC). Further, the controller according to technology disclosed herein may be implemented by a combination of software configuration and hardware configuration.

Obviously, various modifications may be implemented within a range not departing from the spirit of the present invention.

The disclosure of Japanese Patent Application No. 2016-056211, filed Mar. 18, 2016, is incorporated herein by reference in its entirety.

All publications, patent applications, and technical standards mentioned in this present specification are herein incorporated by reference to the same extent as if each individual publication, patent application, or technical standard was specifically and individually indicated to be incorporated by reference.

### REFERENCE SIGNS LIST

10 laser processing device
12 optical system
14, 16 laser source
18, 20, 22, 24 lens
30 laser processing device
32 optical system
34, 36 laser source
38, 40, 42 lens
50 laser processing device
52 optical system
54, 56 minor
58 lens
70 laser processing device
72 optical system
74, 76 laser source
78 polarizing prism
80 ¼ waveplate
82, 84, 86 lens
90 laser processing device
92 optical system
93, 94 laser source
95 dichroic minor
96, 97, 98 lens
100 processing light generator
102 laser source
104 lens
200 metal powder supplying mechanism
202 nozzle
204 metal powder/conveyance gas channel
206 shielding gas channel
Car carrier component
Env envelope component
L1, L1 light beam
PG powder-mixed gas
SG shielding gas
P processing point
R1, R2 focus diameter
S superimposition spot
S1 to S5 spot
OA superimposition region
NA no-superimposition region
W workpiece

1. A laser processing device comprising:
a plurality of laser sources; and
a focusing section that focuses respective light beams of the plurality of laser sources to form a plurality of focus points on a workpiece, such that respective portions of at least some of the plurality of focus points are overlapping, wherein:
the plurality of laser sources have mutually different wavelengths, and
the laser processing device further comprises a controller that:
when performing laser processing, after melting the workpiece at a region where a plurality of the focus points are overlapped, controls an input heat profile at a region within each of the plurality of the focus points where the plurality of focus points do not overlap, and
controls absorption characteristics of the workpiece with a carrier component of a superimposition beam generated by superimposing light beams from each of the plurality of the laser sources, wherein wavelengths of the each of the plurality of the laser sources are selected in order to raise the absorption characteristics.

2-4. (canceled)

5. The laser processing device of claim 1, wherein:
respective lights of the plurality of laser sources have different wavelengths, sizes of the plurality of focus points differ from one another, and
one of the focus points internally encompasses another of the focus points.

6. (canceled)

7. The laser processing device of claim 1, wherein
the focusing section includes an optical system that focuses each of the respective light beams.

8. A three-dimensional shaping device comprising:
a laminating section including a material supply section that supplies a material for performing lamination to form a laminated object; and
the laser processing device of claim 1,
wherein the laminating section performs lamination by:
supplying the material onto the laminated object from the material supply section while moving the laminated object relative to the material supply section and the light beams, and
emitting the light beams onto the supplied material.

9. A laser processing method performed by a laser processing device that includes a plurality of laser sources and a focusing section that focuses respective light beams of the plurality of laser sources to form a plurality of focus points on a workpiece, the laser processing method comprising:
focusing using the focusing section such that respective portions of at least some of the plurality of focus points are overlapping, wherein:
the plurality of laser sources have mutually different wavelengths; and
the laser processing method further comprises:
melting the workpiece in a region where the plurality of the focus points are overlapped,
controlling an input heat profile at a region within each of the plurality of the focus points where the plurality of focus points are not overlapped, and
controlling absorption characteristics of the workpiece with a carrier component of a superimposition beam generated by superimposing light beams from each of the plurality of the laser sources, wherein wavelengths of the each of the plurality of the laser sources are selected in order to raise the absorption characteristics.

10. (canceled)
